(19) United States
(12) Patent Application Publication
(10) Pub. No.: US 2007/0067797 A1
(43) Pub. Date: Mar. 22, 2007

(54) Package metadata and targeting/synchronization service providing system using the same

(76) Inventors: Hee-Kyung Lee, Daejon (KR); Jae-Gon Kim, Daejon (KR); Jin-Soo Choi, Daejon (KR); Jin-Woong Kim, Daejon (KR); Kyeong-Ok Kang, Daejon (KR)

Correspondence Address: LADAS & PARRY LLP, 224 SOUTH MICHIGAN AVENUE, SUITE 1600, CHICAGO, IL, 60604, US

(21) Appl. No.: 10/573,536

(22) PCT Filed: Sep. 25, 2004
(86) PCT No.: PCT/KR04/02494

§ 371 Date: Mar. 27, 2006

(30) Foreign Application Priority Data
Sep. 27, 2003 (KR) 10-2003-0067204
Nov. 17, 2003 (KR) 10-2003-0080903
Mar. 23, 2004 (KR) 10-2004-0019533

(51) Int. Cl. H04N 5/445; H04N 7/025; H04N 7/10; G06F 3/00

(52) U.S. Cl. 725/35; 725/34; 725/46

(57) ABSTRACT

Provided are package metadata and a targeting and synchronization service providing system using the same. The package metadata for a targeting and synchronization service that can provide a variety of contents formed of components to diverse terminals in the form of a package in a targeting and synchronization service providing system, the package metadata which include: package description information for selecting a package desired by a user and describing general information on an individual pack-age to check whether the selected package can be acquired; and container metadata for describing information on a container which is a combination of diverse packages and formed of a set of items, each of which is a combination of components.

### TECHNICAL FIELD

The present invention relates to a package metadata and targeting/synchronization service providing system; and, more particularly, to a package metadata and targeting and synchronization service providing system that can apply Digital Item Declaration (DID) of a Moving Picture Experts Group (MPEG) 21 to television (TV)-Anytime service.

### BACKGROUND ART

Targeting and synchronization service, which is now under standardization progress in Calls For Contributions (CFC), which is Television (TV)-Anytime Phase 2 of Metadata Group, is similar to a personal program service which is appropriate for an environment that consumes user preference suggested conventionally and new types of contents including video, audio, image, text, Hypertext Markup Language (HTML) (refer to TV-Anytime contribution documents AN 515 and AN 525).

That is, the targeting and synchronization service automatically filters and delivers personalized content services properly to a terminal, a service environment, and user profile in consideration of synchronization between contents.

Hereafter, the targeting and synchronization service scenario will be described in detail.

Family members of a family consume. audio/video (AV) programs in their own ways in a home network environment connecting diverse media devices, such as Personal Digital Assistant (PDA), Moving Picture Experts Group (MPEG) Audio Layer 3 (MP3) player, Digital Versatile Disc (DVD) player and the like.

For example, the youngest sister who is an elementary school student likes to watch a sit-com program on a High-Definition (HD) TV. On the other hand, an elder sister who is a college student likes to watch a sit-com program with a Personal Digital Assistant (PDA) through multi-lingual audio stream to improve her language skill.

As show above, the contents consumption pattern is different according to each person and it depends on a variety of conditions such as terminals, networks, users, and types of contents.

Therefore, a contents and service provider in the business of providing a personalized service properly to a service environment and user profile requires a targeting service necessarily.

Also, the TV-Anytime phase 2 allows users to consume not only the simple audio/video for broadcasting but also diverse forms of contents including video, audio, moving picture, and application programs.

The different forms of contents can make up an independent content, but it is also possible to form a content with temporal, spatial and optional relations between them. In the latter case, a synchronization service which describes the time point of each content consumption by describing the temporal relations between a plurality of contents is necessary to make a user consume the content equally with the other users or consume it in the form of a package consistently even though it is used several times.

There is an attempt to apply the MPEG-21 Digital Item Declaration (DID) structure to the embodiment of metadata for TV-Anytime targeting and synchronization service.

FIG. 1 is a diagram showing a conventional schema of the MPEG-21 DID, and FIG. 2 is an exemplary view of a Digital Item (DI) defined by the conventional MPEG-21 DID.

As shown in FIG. 1, DID elements of MPEG-21 defined by 16 elements can form a digital item including different media such as audio media (MP3) and image media (JPG), which is shown in FIG. 2.

The basic structure of the MPEG-21 DID can be used usefully to embody package metadata for TV-Anytime targeting and synchronization service but the problem is that the DID elements of MPEG-21 are too comprehensive to be applied to the TV-Anytime service.

Therefore, it is required to embody package metadata that can supplement the DID elements more specifically in a TV-Anytime system to provide an effective targeting and synchronization service.

In order to identify packages and constitutional elements, the temporal and spatial formation of the constitutional elements and the relation between them should be specified. Also, metadata for conditions describing a usage environment in which the target service is used should be specified, and metadata for describing information on the types of the components should be embodied specifically.

### DISCLOSURE OF INVENTION

Technical Problem

In order to cope with the above requests, the present invention provides package metadata for a targeting and synchronization service and a targeting and synchronization service providing system by applying Digital Item Declaration (DID) of Moving Picture Experts Group (MPEG)-21 efficiently.

Other objects and advantages of the present invention can be understood in the following descriptions and they can be understood more clearly from the embodiments of the invention. Also, it can be understood easily that the objects and advantages of the present invention can be realized by the means described in claims and combinations thereof.

Technical Solution

In accordance with one aspect of the present invention, there are provided package metadata for a targeting and synchronization service that can provide a variety of contents formed of components to diverse terminals in the form of a package in a targeting and synchronization service providing system, the package metadata which include: package description information for selecting a package desired by a user and describing general information on an individual package to check whether the selected package can be acquired; and container metadata for describing information on a container which is a combination of diverse packages and formed of a set of items, each of which is a combination of components.

In accordance with another aspect of the present invention, there is provided a targeting and synchronization service providing system using package metadata for providing a variety of contents, each formed of components, in the form of a package by targeting and synchronizing the contents to diverse types of terminals, the system which includes: a content service providing unit for providing the contents and package metadata; a targeting and synchronization service providing unit for receiving and storing the contents and the package metadata, obtaining a component and a content matched with service request conditions requested by each terminal through analysis, and providing the matched component and content; and a terminal controlling/reproducing unit for transmitting the service request conditions which are requested by the terminal to the targeting and synchronization service providing unit, and receiving the content and the component matched with the service request conditions from the targeting and synchronization service providing unit.

Advantageous Effects

The present invention described above can apply Moving Picture Experts Group (MPEG)-21 Digital Item Declaration (DID) to television (TV)-Anytime service effectively by discriminating constitutional elements from packages, specifying temporal, spatial, and interactive relation between the constitutional elements, specifying conditions of metadata describing an environment used for a targeting and synchronization service, and providing concrete metadata describing each constitutional element.

Also, the present invention can provide package metadata for a targeting/synchronization service and a targeting/synchronization service providing system.

In addition, the present invention can provide a targeting/synchronization service effectively in an MPEG environment by utilizing MPEG-21 DID and embodying the package metadata.

### BRIEF DESCRIPTION OF DRAWINGS

The above and other objects and features of the present invention will become apparent from the following description of the preferred embodiments given in conjunction with the accompanying drawings, in which:

FIG. 1 is an entire schema structure of Moving Picture Experts Group (MPEG)-21 Digital Item Declaration (DID) according to prior art;

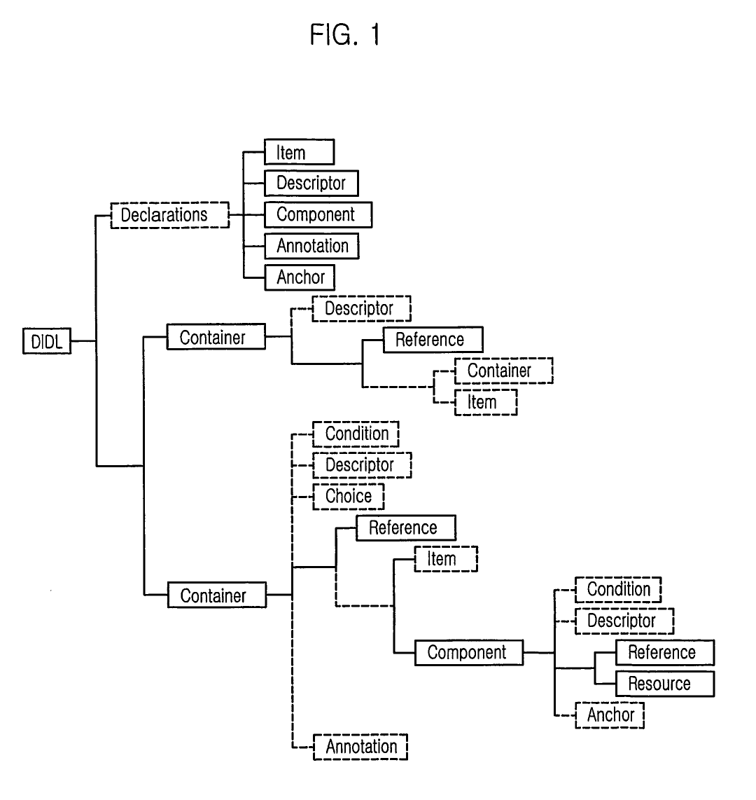

FIG. 2 is an exemplary view of a Digital Item (DI) formed by a conventional MPEG-21 DID;

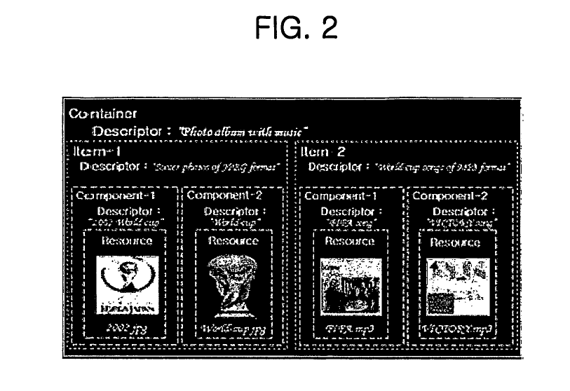

FIG. 3 is a block diagram describing a targeting and synchronization service providing system in accordance with an embodiment of the present invention;

FIG. 4 is a tree diagram illustrating component identification information in accordance with an embodiment of the present invention;

FIG. 5 is a block diagram illustrating package metadata in accordance with an embodiment of the present invention;

FIG. 6 is a diagram describing a usage environment description tool of MPEG-21 Digital Item Adaptation (DIA);

FIG. 7 is diagram illustrating package metadata in accordance with another embodiment of the present invention; and

FIG. 8 is an exemplary view showing a use case of an education package utilizing the package metadata in accordance with an embodiment of the present invention.

Reference numerals of principal elements and description thereof

10: targeting and synchronization service provider

20: contents service provider

30: return channel server

40: PDR

11: storage

12: service analyzer

13: service controller

### BEST MODE FOR CARRYING OUT THE INVENTION

The above and other objects, features, and advantages of the present invention will become apparent from the following description and thereby one of ordinary skill in the art can embody the technological concept of the present invention easily. In addition, if further detailed description on the related prior art is determined to blur the point of the present invention, the description is omitted. Hereafter, preferred embodiments of the present invention will be described in detail with reference to the drawings. The terms or words used in the claims of the present specification should not be construed to be limited to conventional meanings and meanings in dictionaries and the inventor(s) can define a concept of a term appropriately to describe the invention in the best manner. Therefore, the terms and words should be construed in the meaning and concept that coincide with the technological concept of the present invention.

The embodiments presented in the present specification and the structures illustrated in the accompanying drawings are no more than preferred embodiments of the present invention and they do not represent all the technological concept of the present invention. Therefore, it should be understood that diverse equivalents and modifications exist at a time point when the present patent application is filed.

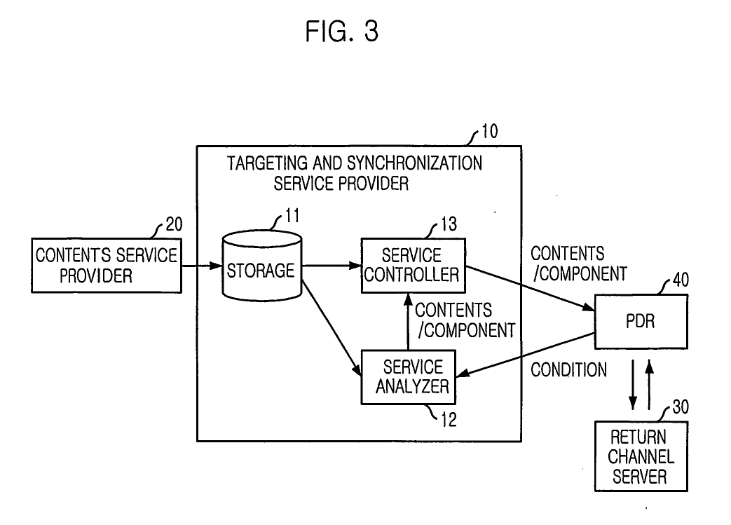

FIG. 3 is a block diagram describing a targeting and synchronization service providing system in accordance with an embodiment of the present invention.

As shown in FIG. 3, the targeting and synchronization service providing system of the present invention comprises a targeting and synchronization service provider 10, a content service provider 20, a return channel server 30, and a personal digital recorder (PDR) 40.

The targeting and synchronization service provider 10 manages and provides a targeting and synchronization service in a home network environment in which a multiple number of devices are connected.

Also, the targeting and synchronization service provider 10 receives package metadata for targeting and synchronization, which are metadata for targeting and synchronization, through the PDR 40 which is a personal high-volume storage from the content service provider 20. The package metadata are important and basis data for determining the kind of a content or a component that should be transmitted to each home device.

The package metadata describe a series of condition information, contents and components information that is suitable for each condition. The actual content and component corresponding to the package metadata are provided by the content service provider 20 or another return channel server 30.

Meanwhile, the targeting and synchronization service provider 10 includes a content and package metadata storage 11, a targeting and synchronization service analyzer 12, and a targeting and synchronization controller 13.

The content and package metadata storage 11 stores contents and package metadata transmitted from the content service provider 20.

The targeting and synchronization service analyzer 12 analyzes inputted package metadata containing a variety of terminals and user conditions from a PDR 40 and determines a content or a component that is matched with the input conditions. Herein, the content or component selected appropriately for the input conditions may be only one or may be a plurality of them.

The targeting and synchronization controller 13 provides attractive metadata and content/component identification information to the PDR 40.

If the analysis result of the targeting and synchronization service indicates that a plurality of contents or components are matched, the PDR user selects and consumes the most preferred content or component based on the attractive metadata.

Hereafter, a method for identifying the package and component will be described. The package is formed of diverse types of multimedia contents such as video, audio, image, application programs and the like, and the location of the package is determined as follows.

If a package is selected in a searching process, the identification (ID) of the package is transmitted in the process of determining the location of the package. Differently from a conventional component determining process which is terminated after a content is acquired, the package location determination of the present invention further includes a step of selecting an appropriate component in the usage environment after the step of acquiring package metadata and a step of determining the location of the selected component.

The steps of determining the location of the package, selecting the appropriate component, and determining the location of the selected component are carried out in different modules with different variables, individually. In the process. of determining the location of the package, it does not need to know what factors determine the package, because the metadata of the package are simply sent to middleware for TV-Anytime metadata. Therefore, the ID of the package can be Content Referencing Identifier (CRID) which is the same as the ID of the content.

Table 1 shows Extended Markup Language (XML) syntax of package identification information embodied in the form of CRID.

TABLE 1

```
<PackageDescription>
  <PackageInformationTable>
    <Container crid=“crid://www.imbc.com/Package/Education/
    CNNEng_Kor”>
      <Item>
```

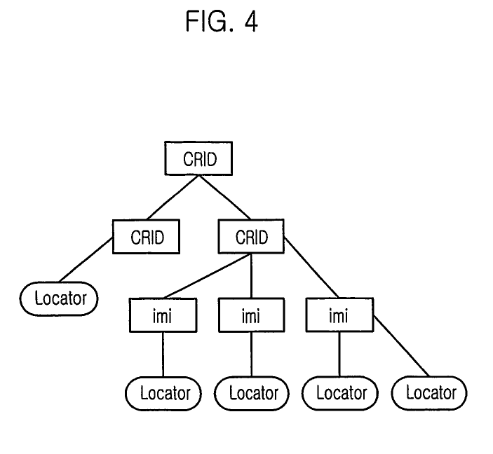

FIG. 4 is a tree diagram illustrating component identification information in accordance with an embodiment of the present invention.

As shown in FIG. 4, the component identification information of the present invention includes imi, CRID and a locator.

In order to determine the location of the component without control of the user automatically, the component should have an identifier that can identify the advantage of media having a different bit expression, just as others. As the identification information of the component, CRID can be used along with an arbitrary identifier, i.e., imi.

The arbitrary identifier, imi, is allocated to each locator to obtain a location-dependent version based on each content and it is expressed in the described metadata.

The locater is changed according to a change in the location of the content. However, the identifier is not changed. The identifier of metadata is secured only within the valid range of CRID which is used by being linked with metadata containing information reproduced during the location determination process.

Table 2 shows an example of component identification information embodied in the XML in accordance with the present invention, and Table 3 presents the above-described package and component determination process.

```
TABLE 2
<Item>
  <Component>
    <Condition require=“Audio_WAV”/>
    <Resource mimeType=“audio/wav” crid=“crid://www.imbc.com/
    EngScriptperPhrase/FirstPhrase” imi=“imi:1”/>
  </Component>
  <Component>
    <Condition require=“Audio_MP3”/>
    <Resource mimeType=“audio/mp3” crid=“crid://www.imbc.com/
    EngScriptperPhrase/FirstPhrase” imi=“imi:2”/>
  </Component>
</Item>
```

TABLE 3

| Procedure | Sub-Procedure | Result | Note |
|---|---|---|---|
| Search | User interaction | CRID of | Same as |
| Package | | Package | the CR for |
| Metadata | | metadata | Content |
| Location | Using authority of package | Physical | |
| Resolution & | ID (CRID) and RAR, | Location of | |
| Acquisition | determine the location of | Package | |
| of | resolution server. | Metadata | |
| Package | Send CRID to an appropriate | | |
| Metadata | location handler | | |
| | Location handler looking for | | |
| | broadcasting channel or | | |
| | requesting get_Data to bi- | | |
| | directional location | | |
| | resolution server | | |
| | Get the location of package | | |
| | metadata | | |
| | Acquisition of package | Package | |
| | metadata | Metadata | |
| Choice of | To make a choice of | List of | Additional |
| Items/ | items/components automatic | Components | steps for |
| Components | without user intervention, | | Package |
| | usage description is used. | | |
| Resolution of | Get the location of | Physical | |
| Components | component using CRID + imi | Location of | |
| | | Component | |
| Acquisition | Acquisition of component | Components | |
| of Components | | | |

Hereafter, package metadata for the targeting and synchronization service in accordance with the present invention will be described. However, description on an element that performs the same function as an element of the MPEG-21 DID under the same name is omitted.

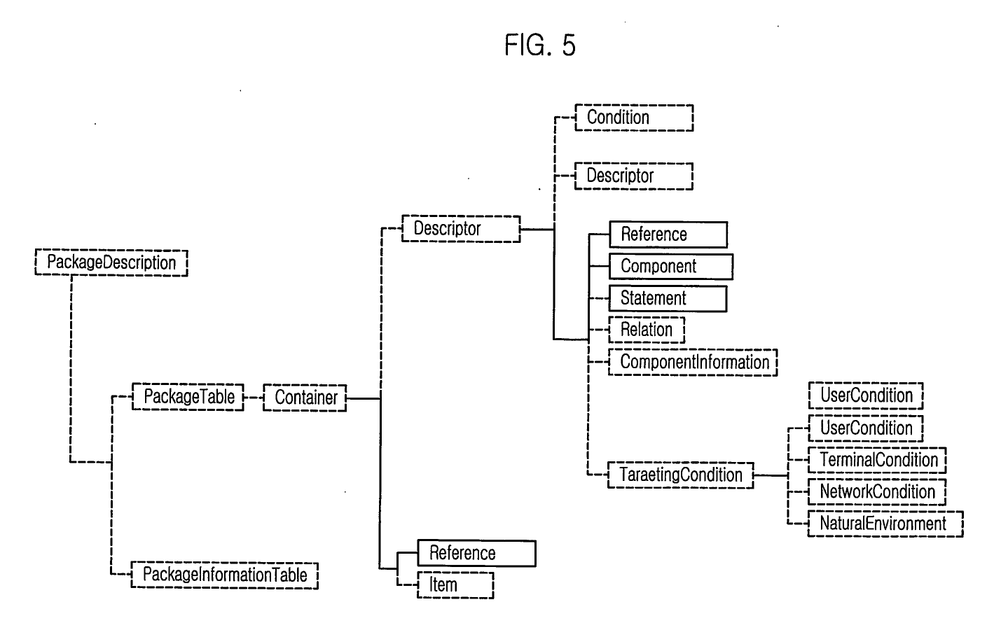

FIG. 5 is a block diagram illustrating the package metadata in accordance with an embodiment of the present invention.

As illustrated in FIG. 5, the package metadata (PackageDescription) of the present invention include a package information table (PackageInformation Table) and a package table (Package Table).

The package information table (PackageInformation Table) provides description information for each package, such as the title of the package, summarized description, and package ID. It allows the user to select a package the user wants to consume and check whether the selected package can be acquired.

The package table (Package Table) is a set of packages and a package is a collection of components that can widen the experience of the user by being combined diversely. The package table (Package Table) can be described through container metadata.

Herein, the container metadata include ‘descriptor,’ ‘reference,’ and ‘item.’

The ‘item’ is a combination of components and it forms a container. It can include an item and a component recursively. The ‘reference’ is information for identifying a package and a component, which is described above, and it describes the location of an element, such as an item and a component.

Also, the “descriptor” is information describing a container and it includes ‘condition,’ ‘descriptor,’ ‘reference,’ ‘component,’ ‘statement,’ relation metadata, component metadata, and targeting and condition (Targeting Condition) metadata.

Hereafter, the component metadata will be described. The component metadata include identification information, component description metadata for describing general particulars of a component, and it further includes image component metadata, video component metadata, audio component metadata or application program component metadata according to the type of the component.

As described above, the identification information includes CRID, imi, and a locator.

The component description (BasicDescription) metadata have a complicated structure that defines items describing general particulars of a component. It includes information describing general particulars such as title of the component, component description information (Synopsis), and keywords. The keywords form combinations of keywords for the component, and both a single keyword and a plurality of keywords are possible. The keywords follow the keyword type of the TV-Anytime phase 1.

The image component (ImageComponentType) metadata have a complicated structure for defining elements that describe attributes of image components. It describes media-related attributes of an image, such as a file size, and still image attributes (StillImageAttributes) information, such as a coding format, vertical/horizontal screen size and the like.

Table 4 below is an embodiment of the image component metadata which is obtained by embodying a 702×240 gif image and a Hypertext Markup Language (HTML) document related thereto in the XML.

TABLE 4

```
<Item>
  <Component>
    <Descriptor>
      <ComponentInformation xsi:type=“ImageComponentType”>
        <ComponentType>image/gif</ComponentType>
        <ComponentRole href=
        “urn:tva:metadata:cs:HowRelatedCS:2002:14”>
            <Name xml:lang=“en”>Support</Name>
        </ComponentRole>
        <BasicDescription>
          <Title>Book Recommend(Vocabulary Perfect)</Title>
          <RelatedMaterial>
            <MediaLocator>
              <mpeg7:MediaUri>http://www.seoiln.com/banner/
              vocabulary/-vocabulary.html</mpeg7:MediaUri>
            </MediaLocator>
          </RelatedMaterial>
        </BasicDescription>
        <MediaAttributes>
          <FileSize>15000</FileSize>
        </MediaAttributes>
        <StillImageAttributes>
          <HorizontalSize>720</HorizontalSize>
          <VerticalSize>240</VerticalSize>
          <Color type=“color”/>
        </StillImageAttributes>
      </ComponentInformation>
    </Descriptor>
    <Resource mimeType=“image/gif” crid=“crid://www.imbc.com-
      /ImagesforLinkedMaterial/EnglishBook.gif”/>
  </Component>
</Item>
```

The video component metadata have a complicated structure for defining elements that describe the attributes of a video component. It describes media-related attributes of video such as a file size, audio related attributes of video such as a coding format and channel, image-related attributes of video such as vertical/horizontal screen size, and motion image-related attributes of video such as a bit rate.

The audio component metadata have a complicated structure defining elements that describe attributes of audio components. It describes media-related attributes of audio such as a file size, and audio related attributes such as a coding format and channel.

The application program component metadata have a complicated structure defining elements that describe attributes of an application program component. It describes media-related attributes of an application program such as classification information of the application program and a file size.

Hereafter, the relation metadata will be described. The relation metadata describe relation between the item and component for formation and synchronization between components.

In order to describe the relation metadata, the metadata relation between the component and the item will be described first, hereafter.

A component model can describe diverse ‘relations’ between the components by referring to Classification Schemes (CS) and using terms such as ‘temporal,’ ‘spatial,’ and ‘interaction.’ The components are applied to the items of a package.

The ‘relations’ between defined components, between items, and between components and items are used to represent how the components, items, or components and items are consumed in an abstract level rather than to represent precise synchronization which requires entire scene description such as SMIL, XMT-0 and BIFS simply by using terms pre-defined in the CS.

For example, a component can be consumed prior to other components by using time-related ‘precedes’ without the entire scene description.

Particularly, in the targeting and synchronization service, the relation metadata include interaction CS information for informing relative importance of the components, synchronization CS information for informing a temporal sequence for component consumption, and spatial CS information for informing relative location of each component on a presentation such as user interface.

The relation metadata are refined based on the concept of ‘relations’ defined in the MPEG-7.

The MPEG-7 Multimedia Description Scheme (MDS) includes three types of ‘relations,’ which are ‘Base Relation CS (BaseRelation CS),’ ‘Temporal Relation CS (TemporalRelation CS),’ and ‘Spatial Relation CS (SpatialRelation CS).’

The CSs correspond to the Interaction CS (InteractionCS), the synchronization CS (SyncCS) and the spatial CS (SpatialCS), respectively.

The base relation CS (BaseRelation CS) defines ‘topological relation’ and ‘set-theoretic relation.’ As presented in Table 5 below, the topological relation includes ‘contain’ and ‘touch,’ while the set-theoretic relation includes ‘union’ and ‘intersection.’

Since the topological relation can express a geometrical location of a constitutional element, it is useful to use the topological relation to express the spatial relation. Therefore, the ‘relations’ from ‘equals’ to ‘separated’ are refined and added to the spatial relation CS (SpatialRelation CS).

Herein, although the set-theoretic relation describes an inclusive relation and an exclusive relation, in the present invention, it is defined as describing relative importance of a component.

TABLE 5

| Relation | Inverse | | | Informative |
|---|---|---|---|---|
| Name | Relation | Definition | Properties | Examples |
| equals | equals | B equals C if and only if B = C | Equivalence | 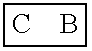 |
| inside | cantains | B₁, B₂ . . . Bₙinside C if and only if (B₁, B₂ . . . Bₙ) [symbol] C | Partial order | 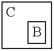 |
| covers | coveredBy | B₁, B₂ . . . Bₙcovers C if and only if B₁ ∪ B₂ ∪ . . . ∪Bₙ ∪ C ⊃ C AND B₁ ∪ B₂ ∪ . . . ∪Bₙ ∪ C) ≠ C | Transitive | 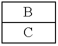 |
| overlaps | overlaps | B overlaps C if and only if B ∩ C has non- empty interior | Symmetric | 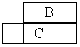 |
| touches | touches | B₁, B₂ . . . Bₙtouches C if and only if B₁ ∪ B₂ ∪ . . . ∪Bₙ ∪ C is connected | Equivalence | 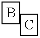 |
| disjoint | disjoint | B disjoints C if and only if B ∩ C = ø | Symmetric | 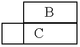 |

TABLE 6

| Term | Relation Description |
|---|---|
| And | Components must be provided for user experience at one time |
| Or | Components can be chosen among them |
| Optional | Components can be consumed or not by user |

In the meantime, the temporal relation CS is as follows. The following tables 7 and 8 describe temporal relation.

The table 7 describes binary temporal relations, whiLe the table 6 describes n-ary temporal relations.

The items of table 8 below are a name of ‘relation’ names in ‘inverse relation’ thereto mathematically, properties of the relations, and usage examples. The table 8 identifies the name of ‘relation,’ defines the relation mathematically, and presents usage examples thereof.

The synchronization CS (SyncCS) can substitute the temporal relation CS (TemporalRelation CS) one-to-one and it can be extended based on table 9 below.

TABLE 7

| | Inverse | | | |
|---|---|---|---|---|
| Relation Name | Relation | Definition | Properties | Examples (informative) |
| precedas | follows | B precedes C | Transitive | BBB CCC |
| | | if and only if | | |
| | | B.b < C.a | | |
| meets | metBy | B meets C | Anti-symmetric | BBBCCC |
| | | if and only if | | |
| | | B.b = C.a | | |
| overlaps | overlappedBy | B overlaps C | | BBB |
| | | if and only if | | CCC |
| | | B.a < C.a AND B.b > C.a | | |
| | | AND B.b < C.b | | |
| contains | during | B contains C | Transitive | Any of the examples for |
| | | if and only if | | strictContains, startedBy, |
| | | (Ca > Ba AND C.b ≦ B.b) | | and finishedBy. |
| | | OR (C.a ≧ B.a | | |
| | | AND C.b < B.b) | | |
| strictContains | strictDuring | B strictContais C | Transitive | BBBBBBB |
| | | if and only if | | CCCC |
| | | C.a > B.a AND C.b < B.b | | |
| starts | startedBy | B starts C | Transitive | BBBB |
| | | if and only if | | CCCCCC |
| | | B.a = C.a AND B.b < C.b | | |
| finishes | finishedBy | B finishes C | Transitive | BBBB |
| | | if and only if | | CCCCCC |
| | | B.a > C.a AND B.b = C.b | | |
| coOccurs | coOccurs | B coOccurs C | Equivalence | BBB |
| | | if and only if | | CCC |
| | | B.a = C.a AND B.b = C.b | | |

TABLE 8

| Relation Name | Definition | Examples (informative) |
|---|---|---|
| contiguous | A₁, A₂, . . . Aₙ contiguous | A₁A₁A₁A₂A₂ . . . AₙAₙAₙ |
| | if and only if | |
| | Aᵢ.b = Aᵢ₊₁.a for i = 1, . . . , n − 1 | |
| | That is, A₁, A₂, . . . Aₙ contiguous if and only | |
| | if they are temporally disjoint and connected. | |
| sequential | A₁, A₂, . . . Aₙ sequential | A₁A₁A₁ A₂A₂ . . . AₙAₙAₙ |
| | if and only if | |
| | Aᵢ.b ≦ Aᵢ₊₁.a for i = 1, . . . , n − 1 | |
| | That is, A₁, A₂, . . . Aₙ sequential if and only if | |
| | they are temporally disjoint and not necessarily | |
| | connected. | |
| coBegin | A₁, A₂, . . . Aₙ coBegin | A₁A₁A₁ |
| | If and only if | A₂A₂ |
| | Aᵢ.a = Aᵢ₊ᵢ.a for i = 1, . . . , n − 1 | . . . |
| | That is, A₁, A₂, . . . Aₙ coBegin if and only if | AₙAₙAₙ |
| | they start at the same time. | |
| coEnd | A₁, A₂, . . . Aₙ coEnd | A₁A₁A₁ |
| | if and only if | A₂A₂ |
| | Aᵢ.b = Aᵢ₊₁.b for i = 1, . . . , n − 1 | . . . |
| | That is, A₁, A₂, . . . Aₙ coEnd if and only if | AₙAₙAₙ |
| | they end at the same time. | |
| parallel | A₁, A₂, . . . Aₙ parallel | A₁A₁A₁ |
| | if and only if | A₂A₂ |
| | the intersection of A₁, A₂, . . . Aₙ has one non- | . . . |
| | empty interior. | AₙAₙAₙ |
| overlapping | A₁, A₂, . . . Aₙ overlapping | A₁A₁A₁ |
| | if and only if | A₂A₂A₂A₂ |
| | the union of A₁, A₂, . . . Aₙ connected and | . . . |
| | each Aᵢ intersects at least one other Aⱼ with | AₙAₙAₙ |
| | non-empty interior. | |

TABLE 9

| Term | Relation Description | MPEG 7 MDS |
|---|---|---|
| TriggeredStart | A component makes the other(s) | starts |
| TriggeredStop | A component makes the other(s) | finishes |
| TriggeredPause | A component makes the other(s) | |
| Before | A component precedes the other(s) | precedes |
| | in presentation time | |
| Behind | A component follows the other(s) in | follows |
| | presentation time | |
| Sequence | Components are started in sequence | sequential |
| ConcurrentlyStart | Components are started at same time | coBegin |
| ConcurrentlyStop | Components are stopped at same time | coEnd |
| Separate | Components are operated at | |
| | different time with a time interval | |
| Overlap | The start time of component is | overlaps |
| | later than that of other one, and | |
| | faster than end time of other one. | |

The following table 10 shows temppral relation between component using the temporal relation CS (TemporalRelation CS).

TABLE 10

```
<Choice minSelections=“1” maxSelections=“1”>
  <Selection select_id=“Temp_coBegin”>
    <Descriptor>
      <Relation type=“urn:mpeg:mpeg7:cs:TemporalRelationCS:
        2001:coBegin”/>
    </Descriptor>
  </Selection>
</Choice>
```

Meanwhile, the spatial relation CS (SpatialRlation CS) will be described hereafter. Table 11 below defines the spatial relation (SpatialRelation). The table 11 identifies the name of relation and the name of inverse relation, defines mathematical relation, describes additional attributes, and presents usage examples in the items.

The relations from ‘south’ to ‘over’ are based on the spatial relation (SpatialRelation). The relations from ‘equals’ to ‘separated’ are added to the ‘SpatialRelation.’ The spatial CS (SpatialCS) can be substituted by the spatial relation CS (SpatialRelation CS) one-to-one and it can be extended by an additional need.

TABLE 11

| Relation | Inverse | | | Informative |
|---|---|---|---|---|
| Name | Relation | Definition | Properties | Examples |
| south | north | B south C if and only if ((B.x.a ≧ C.x.a AND B.x.b ≦ C.x.b) OR (B.x.a ≦ C.x.a AND B.x.b ≧ C.x.b)) AND B.y.b ≦ C.y.a | Transitive | 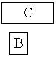 |
| west | east | B west C if and only if B.x.b ≦ C.x.a AND ((B.y.a ≧ C.y.a AND B.y.b ≦ C.y.b) OR (B.y.a ≦ C.y.a AND B.y.a ≧ C.y.b)) | Transitive | 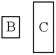 |
| northwest | southeast | B northwest C if and only if B.x.b ≦ C.x.a AND B.y.a ≧ C.y.b | Transitive | 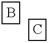 |
| southwest | northeast | B southwest C if and only if B.x.b ≦ C.x.a AND B.y.b ≧ C.y.a | Transitive | 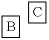 |
| left | right | B left C if and only if B.x.b ≧ C.x.a | Transitive | 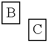 |
| below | above | B below C if and only if B.y.b ≦ C.y.a | Transitive | 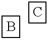 |
| over | under | B over C if and only if ((B.x.a ≦ C.x.a AND B.x.b > C.x.a OR B.x.a > C.x.a AND B.x.a < C.x.b)) AND B.y.a = C.y.b | Transitive | 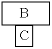 |
| equals | equals | B equals C if and only if B = C | Equi- valence | 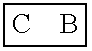 |
| inside | contains | B1, B2, . . . Bn inside C if and only if (B1, B2, . . . Bn) [symbol] C | Partial order | 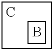 |
| covers | coveredBy | B1, B2, . . . Bn covers C of and only if B1. ∪ B2. ∪ . . . ∪Bn. ∪ C ⊃ C AND B1. ∪ B2. ∪ . . . ∪Bn ∪ C) ≠ C | Transitive | 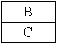 |
| overlaps | overlaps | B overlaps C if and only if B ∩ C has non- empty interior | Symmetric | 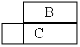 |
| touches | touches | B1, B2, . . . Bn touches C if and only if B1. ∪ B2. ∪ . . . ⊚Bn ∪ C is connected | Equi- valence | 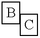 |
| disjoint | disjoint | B disjoint C if and only if B ∩ C = ø | Symmetric | 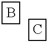 |
| separated | separated | E separated O if and only if E ∩ cl(O) = ø AND cl(E) ∩ = øwhere cl(S) indicates the closure of a set S | Symmetric | 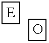 |

Hereafter, the targeting condition metadata will be described. The targeting condition metadata describe usage environment conditions for supporting item/component auto-selection according to a usage environment for targeting.

To describe the targeting condition metadata, the structure of the MPEG-21 DIA, which is used conceptually in the present invention, will be described first.

In order to provide a targeting service that provides more appropriate and efficient user experience for a given usage environment, a package should include a series of usage environment metadata, such- as terminal conditions, user conditions, and content conditions. The usage environment metadata are related with a plurality of constitutional elements in order to represent usage environment conditions needed for consuming the related constitutional elements precisely.

Although there are a lot of non-standardized metadata which describe the usage environment, a usage environment description tool of the MPEG-21 DIA provides abundant description information on diverse attributes in order to provide adaptation for a digital item for transmission, storing and consumption.

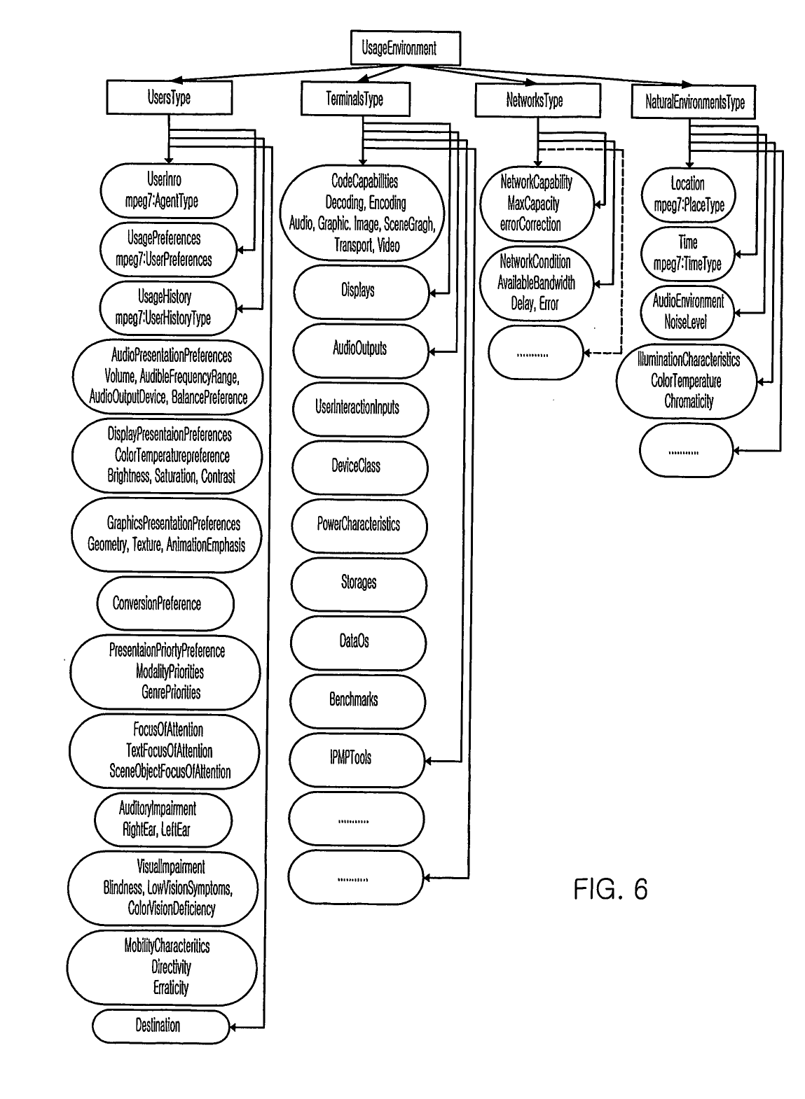

FIG. 6 is a diagram describing a usage environment description tool of the MPEG-21 DIA.

As illustrated in FIG. 6, the tool includes a user type (UserType), a terminal type (TerminalsType), a network type (NetworksType), and a natural environment type (NaturalEnvironmentsType).

The user type (UserType) describes various user characteristics including general user information, usage preference, user history, presentation preference, accessibility characteristic, mobility characteristics, and destination.

The terminal type (TerminalsType) should satisfy consumption and operation restrictions of a particular terminal. The terminal types are defined by a wide variety of terminal kinds and properties. For example, the terminal type is defined by codec capability which includes encoding and decoding capability, device property which include properties of power, storing means and data input/output means, and input-output characteristics which includes display and audio output capabilities.

The network type (NetworkType) specifies network type based on network capability which includes a usable bandwidth, delay characteristic and error characteristic and network conditions. The description can be used for transmitting resources usefully and intensively.

The natural environment type (NaturalEnvironments Type) specifies a natural usage environment which includes location and usage time of a digital item as well as characteristics audio/visual aspects. It also specifies the characteristics of illumination that senses whether visual information is displayed for the visual aspect, and it describes noise level and noise frequency spectrum for the audio aspect.

The targeting condition metadata suggested in the present invention include the properties of the MPEG-21 DIA tool and have an extended structure.

As shown in FIG. 5, the targeting condition metadata of the present invention describe usage environment conditions for supporting automatic item/component selection based on a usage environment. The targeting condition metadata include user condition metadata (UserCondition metadata) which describe a user environment, such as user preference, user history, serge information, visual/auditory difficulty information; terminal condition metadata (TerminalCondition metadata) which describe a terminal environment; network condition metadata (NetworkCondition metadata) which describe a network environment connected with a terminal; and natural environment metadata (NaturalEnvironment metadata) which describe a natural environment such as the location of a terminal.

The following table 12 presents an embodiment of an XML syntax using the targeting condition metadata of the present invention.

```
TABLE 12
<Choice minSelections=“1” maxSelections=“1”>
  <Selection select_id=“Audio_WAV”>
    <Descriptor>
      <TargetingCondition>
        <TerminalCondition xsi:type=“dia:CodecCapabilitiesType”>
          <dia:Decoding xsi:type=“dia:AudioCapabilitiesType”>
            <dia:Format href=
            “urn:mpeg:mpeg7:cs:FileFormatCS:2001:9”>
              <mpeg7:Name xml:lang=“en”>WAV</mpeg7:Name>
            </dia:Format>
          </dia:Decoding>
        </TerminalCondition>
      </TargetingCondition>
    </Descriptor>
  </Selection>
</Choice>
```

In the table 12, “TargetingCondition” includes user terminal descriptive metadata which indicate a terminal capable of decoding a wave file format (wav).

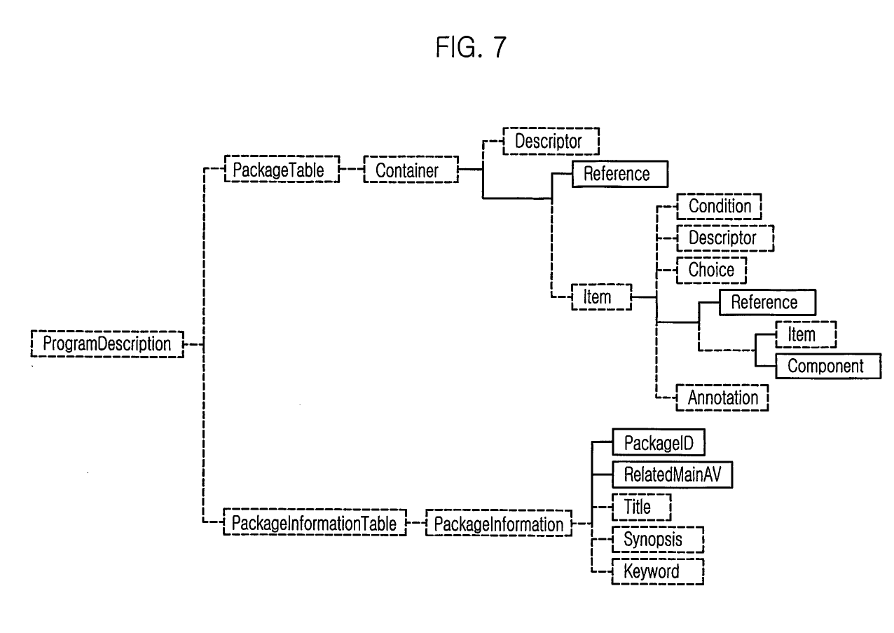

FIG. 7 is diagram illustrating package metadata in accordance with another embodiment of the present invention. The package metadata suggested in the present invention can have the structure illustrated in FIG. 7.

It is obvious that the contents signified by the constitutional elements of FIG. 7 are the same as the contents signified by the constitutional elements of FIG. 5 which have the same name.

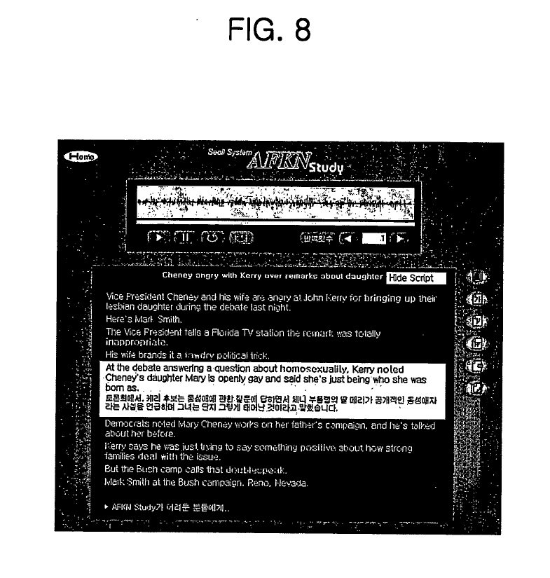

FIG. 8 is an exemplary view showing a use case of an education package utilizing the package metadata in accordance with an embodiment of the present invention.

In a home network environment with a variety of household electric appliances such as Personal Digital Assistants (PDA), Moving Picture Experts Group (MPEG) Audio Layer-3 (MP3) players, and Digital Versatile Disc (DVD) players, it is assumed that a user watches CNN News for studying English. If the user misses part of the news content or comes across a difficult sentence or phrase, the user can refer to education data added to the news content by using a reference identifier.

The education data, particularly, data for language education, can be provided in the form of a package having a plurality of multimedia component such as media player, repeat button, sentence or phrase scripter, directions for exact listening, grammar and dictionary, which is illustrated in FIG. 8.

All the components that form a package should be stored in a PDR (PDR) before the user consumes them. In case where all the components are available, the user interacts with the package rendered to the user interface in the user terminal through an input unit.

The following tables 13 to 16 are XML syntaxes where the education package of FIG. 8 is embodied in the package metadata suggested in the present invention.

TABLE 13
<?xml version=“1.0” encoding=“UTF-8 ”?>
<TVAMain xmlns=“urn: tva:metadata:2002”
xmlns:mpeg7=“urn:mpeg:mpeg7:schema:2001”
xmlns:dia=“urn:mpeg:mpeg21:2003:01-DIA-NS”
xmlns:xsi=“http://www.we.org/2001/XMLSchema-instance”
xsi:schemaLocation=“urn:tva:metadata:2002 ./PackageWithDID2.xsd”>
<PackageDescription>

<PackageInformationTable>

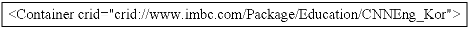

<Item>

<Choice minSelectionsp32 “1” maxSelections=“1”>

<selection select_id=“Phrase_One”>

<Descriptor>

<Statement mimeType=“text/plain”> Phrase One</Statement>

</Descriptor>

</Selection>
<<Selection select_id=“Phrase_Two”>

<Descriptor>

<Statement mimeType=“tert/plain”>Phrase Two</Statement>

</Descriptor>

</Selection>

</Choice>
<Choice minSelections=“1” maxSelections=“2”>

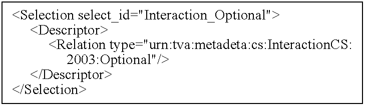

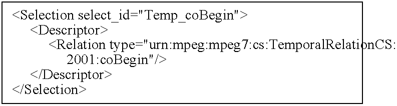

</Choice>
<Choice minSelections=“1” maxSeleation=“1”>

<Selection select_id=“Audio_WAV”>

<Descriptor>

<TargetingCondition>

<TerminalCondition xsi:type=“dia:CodecCapabilitiesType”>

<dia:Decoding xsi:type=“dia:AudioCapabilitiesType”>

<dia:Format href=“urn:mpeg:mpeg7:cs:FileFormatCS

:2001:9”>

TABLE 14

<mpeg7:Name xml:lang=“en”>WAV</mpeg7:Name>

</dia:Format>

</dia:Decoding>

</TerminalCondition>

</TargetingCondition>

</Descriptor>

</Selection>
<Selection select_id=“Audio_MP3”>

<Descriptor>

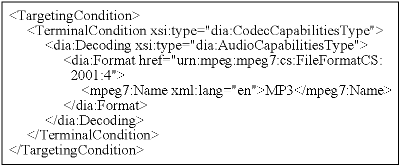

</Descriptor>

</Selection>

</Choice>
<Item>

<Condition require=“Phrace_One Tempo_coBegin”/>
<Item>

<Component>

<Condition require=“Audio_WAV”/>

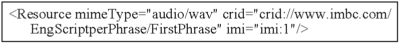

</Component>
<Component>

<Condition require=“Audio_MP3”/>
<Resource mimeType=“audio/mp3” crid=“crid://www.imbc.com/

EngscriptperPhrase//FirstPhrace“ imi=“imi:2”/>

</Component>

</Item>
<Component>

<Resource mimeType=“text/plain” crid=“crid://www.imbc.com/

EngScriptperPhrase/FirstPhrase.txt”/>

</Component>
<Component>

<Resource mimeType=“text/plain” crid=“crid://www.imbc.com/

KorScriptperPhrase/FirstPhrase.txt“/>

</Component>

</Item>

```
TABLE 15
<Item>
  <Condition require=“Phrase_Two Temp_coBegin”/>
  <Component>
    <Resource mimeType=“audio/wav” crid=“crid://www.imbc.com/
      EngScriptperPhrase/SecondPhrase.wav”/>
  </Component>
  <Component>
    <Resource mimeType=“text/plain” crid=“crid://www.imbc.com/
    EngScriptperPhrase/SecondPhrase.txt”/>
  </Component>
  <Component>
    <Resource mimeType=“text/plain” crid=“crid://www.imbc.com/
      KorScriptperPhrase/SecondPhrase.txt”/>
  </Component>
</Item>
<Item>
  <Condition require=“Interaction Optional”/>
    <Component>
      <Descriptor>
        <ComponentInformation xsi:type=“ImageComponentType”>
          <ComponentType>image/gif</ComponentType>
          <ComponentRole href=“urn:tva:metadata:cs:
                HowRelatedCS:2002:14”>
              <Name xml:lang=“en”>Support</Name>
          </ComponentRole>
          <BasicDescription>
            <Title>Book Recommend(Vocabulary Perfect)</Title>
            <RelatedMaterial>
                <MediaLocator>
                  <mpeg7:MediaUri>http://www.seoiln.com/banner/
                  vocabulary/vocabulary.html</mpeg7:MediaUri>
                </MediaLocator>
            </RelatedMaterial>
          </BasicDescription>
          <MediaAttributes>
            <FileSize>15000</FileSize>
          </MediaAttributes>
          <StillImageAttributes>
            <HorizontalSize>720</HorizontalSize>
            <VerticalSize>240</VerticalSize>
            <Color type=“color”/>
          </StillImageAttributes>
        </ComponentInformation>
      </Descriptor>
      <Resource mimeType=“image/gif” crid=“crid://www.imbc.com-
```

TABLE 16

```
                /ImagesforLinkedMaterial/EnglishBook.gif”/>
            </Component>
            <Component>
              <Resource mimeType=“image/gif” crid=“crid://
                www.imbc.com-/ImagesforLinkedMaterial/
                StudyMethod.gif”/>
            </Component>
          </Item>
        </Item>
      </Container>
    </PackageInformationTable>
  </PackageDescription>
</TVAMain>
```

The components in the boxes in the contents of the tables 13 to 15 stand for relation metadata, targeting condition metadata and component metadata in accordance with the present invention.

The method of the present invention can be embodied in the form of a program and stored in a computer-readable recording medium, such as CD-ROM, RAM, ROM, floppy disks, hard disks, electro-optical disks and the like. Since the process can be easily executed by those skilled in the art, further description will be omitted.

While the present invention has been described with respect to certain preferred embodiments, it will be apparent to those skilled in the art that various changes and modifications may be made without departing from the scope of the invention as defined in the following claims.

What is claimed is:

1. A targeting and synchronization service providing system using package metadata for providing a variety of contents, each formed of components, in the form of a package by targeting and synchronizing the contents to diverse types of terminals, the system comprising:
a content service providing means for providing the contents and package metadata;
a targeting and synchronization service providing means for receiving and storing the contents and the package metadata, obtaining a component and a content matched with service request conditions requested by each terminal through analysis, and providing the matched component and content; and
a terminal controlling/reproducing means for transmitting the service request conditions which are requested by the terminal to the targeting and synchronization service providing means, and receiving the content and the component matched with the service request conditions from the targeting and synchronization service providing means.

2. The system as recited in claim 1, wherein the targeting and synchronization service providing means includes:
a storing means for storing the package metadata and the content which are inputted from the content service providing means;
a service analyzing means for analyzing the service request conditions inputted from the terminal controlling/reproducing means and determining a content and a component which are matched with the service request conditions; and
a service controlling means for providing the content and component determined in the service analyzing means to the terminal controlling/reproducing means.

3. The system as recited in claim 2, wherein the package metadata include:
package description information for selecting a package desired by a user and describing general information on an individual package to check whether the selected package can be acquired; and
container metadata for describing information on a container which is a combination of diverse packages and formed of a set of items, each of which is a combination of components.

4. The system as recited in claim 3, wherein the container metadata include:
descriptor information for describing information on a container;
reference information including identification information for describing locations of packages and components included in the container; and
item description information for describing information on the items included in the container.

5. The system as recited in claim 4, wherein the descriptor information includes:
component metadata for describing general information on the components and information for each type of components;
relation metadata for describing relation between items and components for forming and synchronizing components; and
targeting condition metadata for describing conditions for a usage environment of the terminal to provide a targeting service for selecting an item and a component based on the diverse conditions of the terminal.

6. The system as recited in claim 6, wherein the component metadata include:
component description metadata for describing general particulars of a component;
image component metadata for describing image attributes of an image component;
video component metadata for describing video attributes of a video component;
audio component metadata for describing audio attributes of an audio component; and
application program component metadata for describing application program attributes of an application program component.

7. The system as recited in claim 6, wherein the image attributes include a file size, a coding format, and a vertical/horizontal screen size.

8. The system as recited in claim 6, wherein the video attributes include media attributes of video, audio attributes of video, image attributes of video, and motion video attributes of video.

9. The system as recited in claim 6, wherein the audio attributes include a file size, a coding format, and channel information.

10. The system as recited in claim 6, wherein the application program attributes include application program classification information and media attribute information of the application program.

11. The system as recited in claim 5, wherein the relation metadata include:
interaction relation information for describing relative importance between the components;
temporal relation information for describing a temporal sequence of component consumption; and
spatial relation information for describing relative locations of the components on presentation based on a user interface.

12. The system as recited in claim 5, wherein the targeting condition metadata include:
user condition information for describing user environment characteristics;
terminal condition information for describing terminal environment characteristics;
network condition information for describing network environment characteristics connected with the terminal; and
natural environment information for describing natural environment characteristics such as the location of a terminal.

13. The system as recited in claim 12, wherein the user environment characteristics include a user preference, user history, surge information and visual/auditory difficulty information.

14. The system as recited in claim 12, wherein the terminal environment characteristics include codec capability, device attributes, and input/output characteristic information.

15. The system as recited in claim 12, wherein the network environment characteristics include a bandwidth of a network connected with the terminal, a delay characteristic and an error characteristic.

16. The system as recited in claim 12, wherein the natural environment characteristics include characteristics of audio/visual aspects, location information, and usage time of a digital item.

17. The system as recited in claim 4, wherein the identification information includes an arbitrary identifier, CRID, and a tree structure of a locator.

18. Package metadata for a targeting and synchronization service that can provide a variety of contents formed of components to diverse terminals in the form of a package in a targeting and synchronization service providing system, the package metadata comprising:
package description information for selecting a package desired by a user and describing general information on an individual package to check whether the selected package can be acquired; and
container metadata for describing information on a container which is a combination of diverse packages and formed of a set of items, each of- which is a combination of components.

19. The package metadata as recited in claim 18, wherein the container metadata include:
descriptor information for describing information on a container;
reference information including identification information for describing locations of packages and components included in the container; and
item description information for describing information on the items included in the container.

20. The package metadata as recited in claim 19, wherein the descriptor information includes:
component metadata for describing general information on the components and information for each type of components;
relation metadata for describing relation between items and components for forming and synchronizing the components; and
targeting condition metadata for describing conditions for a usage environment of the terminal to provide a targeting service for selecting an item and a component based on the diverse conditions of the terminal.

21. The package metadata as recited in claim 20, wherein the component metadata include:
component description metadata for describing general particulars of a component;
image component metadata for describing image attributes of an image component;
video component metadata for describing video attributes of a video component;
audio component metadata for describing audio attributes of an audio component; and
application program component metadata for describing application program attributes of an application program component.

22. The package metadata as recited in claim 21, wherein the image characteristics include a file size, a coding format, and a vertical/horizontal screen size.

23. The package metadata as recited in claim 21, wherein the video attributes include media attributes of video, audio attributes of video, image attributes of video, and motion video attributes of video.

24. The package metadata as recited in claim 21, wherein the audio attribute includes a file size, a coding format, and channel information.

25. The package metadata as recited in claim 21, wherein the application program attributes include a classification information of an application program and media attribute information of an application program.

26. The package metadata as recited in claim 20, wherein the relation metadata include:
interaction relation information for describing relative importance between the components;
temporal relation information for describing a temporal sequence of component consumption; and
spatial relation information for describing relative location of the components on presentation based on a user interface.

27. The package metadata as recited in claim 20, wherein the targeting condition metadata include:
user condition information for describing a user environment attribute;
terminal condition information for describing a terminal environment attribute;
network condition information for describing a network environment attribute connected with the terminal; and
natural environment information for describing a natural environment attribute such as the location of the terminal.

28. The package metadata as recited in claim 27, wherein the user environment characteristics include a user preference, user history, surge information and visual/auditory difficulty information.

29. The package metadata as recited in claim 27, wherein the terminal environment characteristics include a codec capability, device attributes, and input/output characteristic information.

30. The package metadata as recited in claim 27, wherein the network environment characteristic includes a bandwidth of a network connected with the terminal, a delay characteristic and an error characteristic.

31. The package metadata as recited in claim 27, wherein the natural environment characteristics include characteristic of audio/visual aspects, location information, and usage time of a digital item.
